(19) United States
(12) Patent Application Publication
(10) Pub. No.: US 2017/0170927 A1
(43) Pub. Date: Jun. 15, 2017

(54) Network Interface Port Modes

(71) Applicant: BROADCOM CORPORATION, IRVINE, CA (US)

(72) Inventors: ROBERT JOHN STONE, BERKELEY, CA (US); ERIC ALLEN BADEN, SARATOGA, CA (US); ANKIT SAJJAN KUMAR BANSAL, SAN JOSE, CA (US)

(21) Appl. No.: 15/374,817

(22) Filed: Dec. 9, 2016

Related U.S. Application Data
(60) Provisional application No. 62/426,115, filed on Nov. 23, 2016.
(60) Provisional application No. 62/266,560, filed on Dec. 11, 2015.

(51) Int. Cl. H04L 1/00; H04L 29/06

(52) U.S. Cl. CPC H04L 1/0057; H04L 69/04; H04L 1/0042; H04L 69/324

(57) ABSTRACT

A system includes a network interface port. The network interface port may support a network interface port mode implementing one or more physical lanes. The network interface port mode may support one or more logical lanes transported over the physical lanes. The network interface port mode may implement transfer using a specified baud rate and signaling scheme. The logical architecture of the transmission and reception stack may be selected based on the operational parameters of the network interface port mode.

### PRIORITY CLAIM

This application claims priority to provisional application serial number 62/266,560, filed Dec. 11, 2015, Attorney Docket No. 14528.01145, titled Multi-Lane Networking Port Modes; and provisional application serial number 62/426,115, filed Nov. 23, 2016, Attorney Docket No. 14528.01166, titled Network Interface Port Modes; each of which being entirely incorporated by reference.

### TECHNICAL FIELD

This disclosure relates to lane bitrates in multi- and single-lane networking.

### BACKGROUND

High speed data networks form part of the backbone of what has become indispensable worldwide data connectivity. Within the data networks, data coding and encapsulation may be used to transport data from a source to a destination. Improvements in network throughput, including improvements in networking modes to support increase throughput, will further enhance performance of data networks.

### BRIEF DESCRIPTION OF THE DRAWINGS

FIG. 1 shows example network nodes within a network.

FIG. 2 shows example network interface transmission circuitry and network interface reception circuitry.

FIG. 3 shows an example coding logic.

FIG. 4 shows example of error correction coding logic.

FIG. 5 shows another example error correction coding logic.

FIG. 6 shows yet another example of error correction coding logic.

FIG. 7 shows another example of error correction coding logic.

FIG. 7 show example network interface transmission port mode parameters.

FIG. 8 show example network interface reception port mode parameters.

### DETAILED DESCRIPTION

The discussion below makes reference to network interface ports and network interface port modes. The network interface ports (e.g., Ethernet ports) may support one or more lanes for multi-lane and single lane network interface port modes. The lanes may support virtually any lane speed (e.g., lane data rate), for example 10 Gb/s, 20 Gb/s, 50 Gb/s, or other lane speeds. In some cases parameters specified for a network interface port mode may be selected based on the number of lanes used in the network interface port mode and the lane speed of the lanes used in the network interface port mode.

The various network interface port modes may be used in conjunction with various networking standards including IEEE 802.3ba, IEEE 802.3bj, IEEE 802.3bm, IEEE 802.3bs, IEEE 802.3by, or other IEEE 802.3 family standards.

Selection of networking mode parameters may be based on lane speed and number of lanes per network interface port. Additionally or alternatively, networking mode parameters may be selected to address issues of interoperability with legacy systems, e.g., backward compatibility. For example, in some cases, 25 Gbaud PAM4 line coding may be selected to facilitate interoperability among 25 Gb/s lane coding schemes and 50 Gb/s line coding schemes.

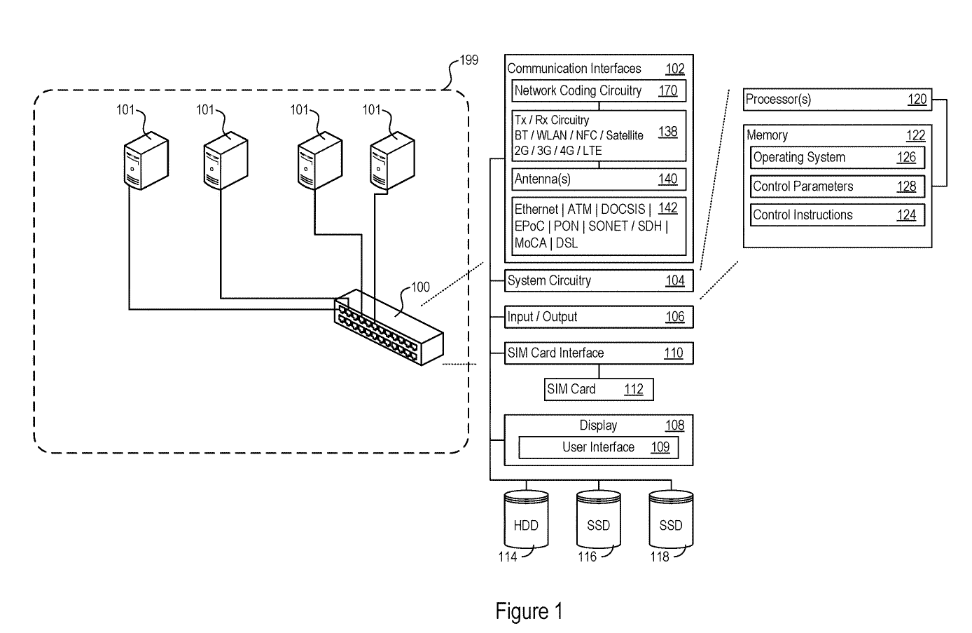

FIG. 1 provides a context for the further discussion of network transmission system. FIG. 1 shows example network nodes 100 within a network 199. In the network 199, networking nodes 100 route packets from sources to destinations across any number and type of networks (e.g., the Ethernet/TCP/IP network). The networking nodes 100 may take many different forms and may be present in any number. The nodes 100 may include routers and switches, set-top boxes, servers, rack mount devices, computers, laptops, televisions, video game consoles, bridges to other networks, or other devices, for instance; however other types of networking nodes 100 may also be present throughout the network 199.

In FIG. 1, an example node 100 includes one or more communication interfaces 102, system circuitry 104, input/output interface circuitry 106, and a display 108 on which the node 100 generates a user interface 109. The example node may couple to hosts 101 via the network 199. The communication interfaces 102 may include transmitter (Tx) and receiver (Rx) circuitry (“transceivers”) 138 and any antennas 140 used by the transceivers 138. The transceivers 138 may provide physical layer interfaces for any of a wide range of communication protocols 142, such as any type of Ethernet, data over cable service interface specification (DOCSIS), digital subscriber line (DSL), multimedia over coax alliance (MoCA), or other protocol. When the communication interfaces 102 support cellular connectivity, the node 100 may also include a SIM card interface 110 and SIM card 112 or any other form of cellular data storage/interface. The example node 100 can also include one or more storage devices, such as hard disk drives 114 (HDDs) and/or solid state disk drives 116, 118 (SDDs).

In some implementations, the transceivers circuitry 138 may include network coding circuitry 170 to support selection and support of network interface port modes.

The user interface 109 and the input/output interface circuitry 106 may include and/or support one or more of a graphical user interface (GUI), touch sensitive display, voice or facial recognition inputs, buttons, switches, speakers and other user interface elements. Additional examples of the input/output interface circuitry 106 supported and/or provided can include one or more of microphones, video and still image cameras, headset and microphone input/output jacks, Universal Serial Bus (USB) connectors, memory card slots, and other types of inputs. The input/output interface circuitry 106 may further include and/or support magnetic or optical media interfaces (e.g., a CDROM or DVD drive), serial and parallel bus interfaces, and keyboard and mouse interfaces.

The system circuitry 104 may include hardware that may execute logical instructions to carry out the processing noted below. The system circuitry 104 may be implemented, for example, with one or more systems on a chip (SoC), application specific integrated circuits (ASIC), discrete analog and digital circuits, and other circuitry. The system circuitry 104 is part of the implementation of any desired functionality in the node 100. In that regard, the system circuitry 104 may include circuitry that facilitates phantom mode transmission over paired conductor media.

The system circuitry 104 may include one or more processors 120 and memories 122. The memory 122 and storage devices 114, 116, 118 store, for example, control instructions 124 and an operating system 126. The processor 120 executes the control instructions 124 and the operating system 126 to carry out any of the described functionality for the node 100. The control parameters 128 provide and specify configuration and operating options for the control instructions 124, operating system 126, and other functionality of the example node 100.

The network coding circuitry 170 may specify multiple port parameters for a given network interface port mode. For example, the network coding circuitry may specify a network interface port data rate, a number of physical lanes, a number or logical lanes (e.g., physical coding sublayer (PCS) lanes, virtual lanes, forward error correction (FEC) lanes, or other logical lanes), a logical lane type (e.g., PCS, virtual, FEC, or other lane types, FEC types (e.g., Reed-Soloman (RS), RS-544, RS-528, Base-R (which may use a cyclic fire code), or other FEC types), a baud rate (e.g., 26.6 Gbaud, 25.8 Gbaud, or other baud rates), a physical signaling scheme (e.g., four-level pulse amplitude modulation (PAM4), or other signaling schemes), RS FEC architecture or other parameters.

Table 1 shows example network interface port modes individually designated by a mode number in the last column.

TABLE 1
Example Network interface port Modes

| | Number | Number | | | | | | | |
|---|---|---|---|---|---|---|---|---|---|
| Port | Of | Of | Logical | | Baud | | | Logical | |
| Rate | Physical | Logical | Lane | FEC | Rate | | RS FEC | Architecture | Mode |
| (Gb/s) | Lanes | Lanes | Type | Type | (Gbaud) | Signaling | Architecture | Type | No. |
| 400 | 8 | 16 | Virtual | None | 25.78125 | PAM4 | N/A | A (300) | 1 |
| 200 | 4 | 8 | FEC | RS-544 | 26.5625 | PAM4 | 2 × 100 | B (400) | 2 |
| | | 8 | FEC | RS-544 | 26.5625 | PAM4 | 1 × 200 | B (400) | 3 |
| | | 8 | Virtual | None | 25.78125 | PAM4 | N/A | A (300) | 4 |
| 100 | 2 | 4 | FEC | RS-544 | 26.5625 | PAM4 | 2 × 50 | B (400) | 5 |
| | | 4 | Virtual | None | 25.78125 | PAM4 | N/A | A (300) | 6 |
| | | 4 | FEC | RS-528 | | PAM4 | 1 × 100 | C (500) | 7 |
| 50 | 1 | 1 | FEC | RS-544 | 26.5625 | PAM4 | 1 × 50 (With | B (400) | 8 |
| | | | | | | | CWMs) | | |
| | | | | | | | (CL82) | | |
| | | 4 | Virtual | None | 25.78125 | PAM4 | N/A | A (300) | 9 |
| | | 2 | FEC | RS-528 | | PAM4 | 1 × 50 (CL82) | B (400) | 10 |
| | | 4 | Virtual | Base-R | | PAM4 | N/A | D (600) | 11 |

The example network interface port modes shown in Table 1 may be used to support 50 Gb/s lane speeds. However, other lane speeds may be used. For example, example network interface port modes 9 and 11 may be used with 25 Gb/s lane speeds and multiple physical lanes. Hence, conversion between 50 Gb/s lane speeds and 25 Gb/s lane speeds for network interface ports using modes 9 or 11 may be accomplished via multiplexing/demultiplexing circuitry. Multiplexing circuitry may join multiple (e.g., two) 25 Gb/s lanes into a 50 Gb/s lane.

Conversely, demultiplexing circuitry may divide a 50 Gb/s lane into multiple 25 Gb/s lanes. Similarly, multiplexing/demultiplexing circuitry may convert network interface ports of a first data rate into ports of second data rate by combining or dividing the lanes of the network interface ports. In an example scenario, a bit-mux gearbox may be implemented as the multiplexing/demultiplexing circuitry. Gearboxes may alter physical lane data rates by “gearing” down or up lane speeds through demultiplexing or multiplexing operations.

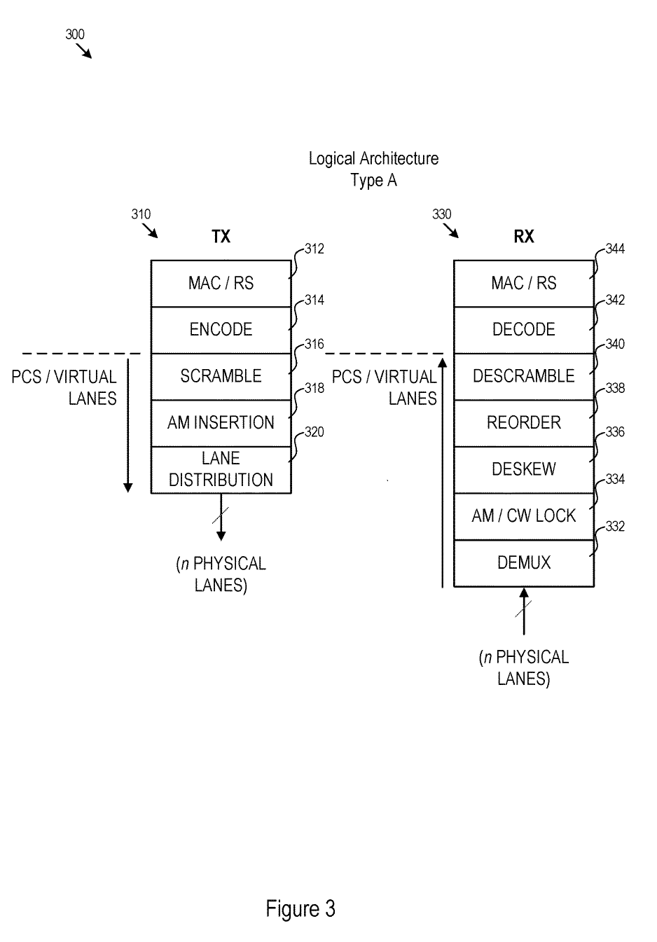

Table 1 makes reference to logical architecture types A, B, C, and D. The Tx/Rx logic and error correction coding discussed below in FIGS. 3, 4, 5, and 6 may implement these architecture types, as discussed below.

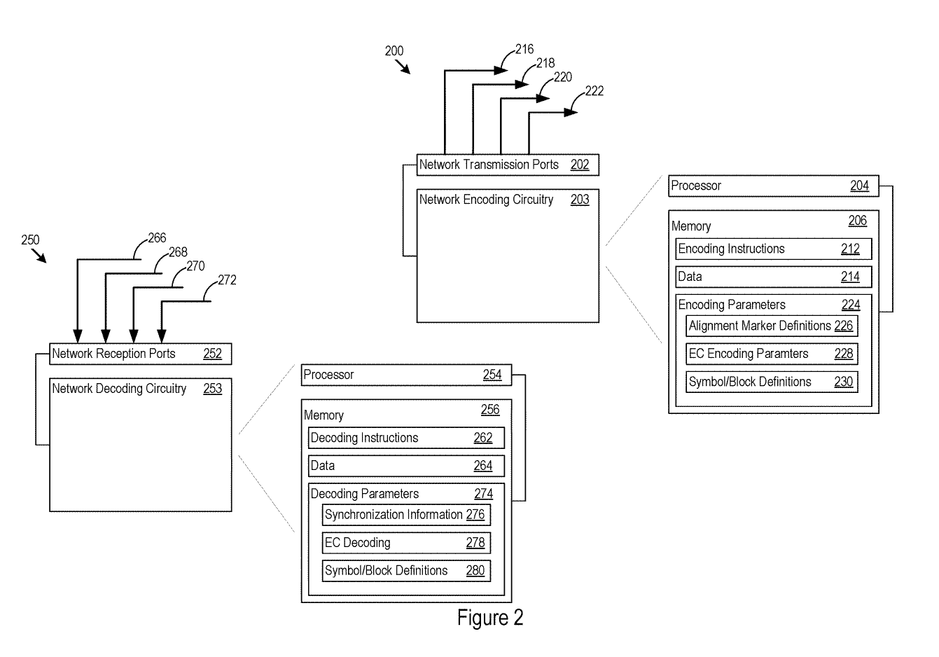

FIG. 2 shows example network interface transmission circuitry (NITC) 200 and network interface reception circuitry (NIRC) 250 that may implement the techniques and architectures described herein. The NITC 200 and NIRC 250 may be integrated within the communication interface 102 in the example node 100. However, the circuitry 200, 250 may be implemented in any device that sends or receives data over logical or physical networking lanes, whether that device is fixed or mobile. The NITC 200 includes network transmission ports 202, e.g., Ethernet ports or other network interface ports, and network encoding circuitry 203. The network encoding circuitry 203 may be implemented in hardware, software, or both. Additionally or alternatively, the network encoding circuitry 203 may include a processor 204 and a memory 206. The memory 206 may store encoding instructions 212, e.g., encoding program instructions, for execution by the processor 204. The network encoding circuitry 203 may implement the techniques described below for transmission, including the transmission aspects described below in connection with FIGS. 3, 4, 5, and 6. The memory 206 may also store transmission data 214 before the data is transmitted over the transmission medium.

FIG. 2 shows four lanes 216, 218, 220, and 222 of data traffic sent by the network interface ports 202 as one particular example. There may be more or fewer lanes. For example, the networking port modes described in Table 1 include modes of up to eight physical lanes and as few as one physical lane. However, other modes including 20 or more physical lanes are possible. In some cases, increasing the number of physical or logical lanes may tend to increase the synchronization overhead of the system.

The encoding instructions 212 operate according to the encoding parameters 224 to perform the error code insertion, alignment marker insertion, encoding, transcoding, and scrambling described below. All of the encoding parameters 224 may vary on a dynamic basis to suit pre-configured or dynamic configuration goals of the NITC 200. For example, the encoding parameters 224 may be changed dynamically by the network encoding logic 203 to increase compatibility with a legacy system when the legacy system is brought online. However, the network encoding circuitry 203 may return the parameters to a non-legacy state when the legacy system is brought offline. The network encoding circuitry 203 may communicate status and other information to other logic in the node 100 to be used in subsequent processing stages.

The encoding parameters 224 may include alignment marker definitions 226. The decoding parameters may further include error correction (EC) encoding parameters 278, and symbol/block definitions 230.

The NIRC 250 includes network reception ports 252 (e.g., Ethernet ports or other network interface ports) and network decoding circuitry 253. The network decoding circuitry 253 may be implemented in hardware, software, or both. Additionally or alternatively, the network decoding circuitry 253 may include a processor 254 and a memory 256. The memory 256 may store decoding instructions 262 (e.g., program instructions) for execution by the processor 254. The network decoding circuitry 203 may implement the techniques described below for reception, including the reception aspects described below in connection with FIGS. 3, 4, 5, and 6. The memory 256 may also store received data 264 before the data is sent on to the other systems.

FIG. 2 shows four lanes 266, 268, 270, and 272 of data traffic received by the network interface ports 252 as one particular example. There may be more or fewer lanes, as discussed above.

In various implementations, the NITC 200 and NIRC may be implemented as unified-duplex network interface circuity (NIC), with two-way network interface ports, and network coding circuitry (e.g., 170) to handle transmission and reception operations.

The decoding instructions 262 operate according to the decoding parameters 274 to perform the decoding, error code decoding, deskewing, descrambling, transcoding, and reordering described below. The decoding parameters 274 may include synchronization information 276, such as match thresholds, deskew information, alignment marker definitions, and lock criteria. The decoding parameters may further include EC decoding parameters 278 and symbol/block definitions 280. All of the decoding parameters 274 may vary on a dynamic basis to suit pre-configured or dynamic configuration goals of the NIRC 250. The network decoding circuitry 253 may communicate status and other information to other logic in the node 100 to be used in subsequent processing stages.

FIG. 3 shows a first example of coding logic 300, including a Tx stack 310 and an Rx stack 330. The logic 300 may implement virtual lanes. In the Tx stack 310, the logic 300 may insert data at the media access control (MAC) layer (312) of an Open systems Interconnection (OSI) Model network computing stack. The data may be encoded (314) to virtual lanes. During encoding, the logic 300 may insert the data into frames of a transport protocol to encapsulate the data. The data may then be scrambled (316) by the logic 300. The scrambling (316) may prevent the transmission of challenging sequences to receive and decode. Examples of transceiver-problematic sequences may include, as examples, long strings of ‘1’s or ‘0’s, particular periodic sequences, or other challenging sequences. The challenging sequences may occur as a result of particular data transmissions, such as, chains of idle words, null data, periodic polling, ACKs or NACKs, or other data sequences. However, the challenging sequences may have a low probability of occurring randomly. Accordingly, in some cases, scrambling the data may increase randomization within the data and reduce the likelihood of occurrence of a challenging sequence. For example, a challenging sequence occurring as a result of a common data sequence, such as a chain of idle or null data, may occur disproportionately often to other possible data sequences. In some cases, the challenging sequences may be transceiver-problematic in that they may lead amplifier or detector saturation during transmission or reception. In some cases, the challenging sequences may be prone to cause symbol errors by causing high duty cycles or high peak-to-average signal sequences.

The logic 300 may insert alignment markers (AM) (318) for the virtual lanes and/or physical lanes. The logic 300 may distribute (320) the data among the physical lanes, e.g., in blocks defined by the alignment markers.

In the Rx stack 330, incoming data on the physical lanes may be demultiplexed (332) by the logic 300. The logic 300 may lock to the alignment markers (334) to deskew the logical lanes (336). The logic 300 may reorder the data in accord with the alignment markers (338), e.g., to mitigate the effect of out-of-order logical or physical lane data transmission. The logic 300 may apply descrambling (340) and decode (342) the data from the virtual lanes. The logic 300 may send the data may to the MAC layer (344).

In some cases, the layering showing the Tx stack 310 and the Rx stack 330 may show the layering on the physical lane lines. For example, the AM insertion (318) occurs below (in the stack) or after (in time) the scrambling (316). Accordingly, the AM blocks may not necessarily be exposed to scrambling. This layering may be implemented architecturally, e.g., by inserting the AM blocks after scrambling or may be implemented logically, e.g., inserting the AM blocks ahead of the scrambling but marking the AM blocks to be skipped during scrambling. Other such architectural/logical inversions may be implemented with other layers in the Tx and Rx stacks 310, 330. Further, the architectural/logical inversions may be implemented with the other example Tx/Rx logic 400, 500, 600 discussed below.

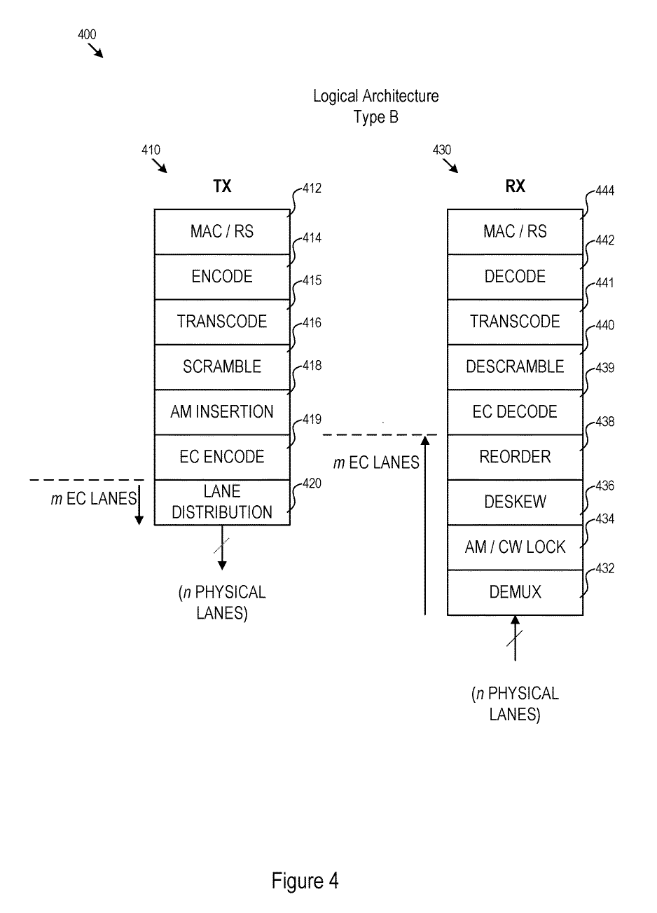

Moving to FIG. 4, an example error correcting coding logic 400 is shown. The logic 400 may be used to implement EC lanes. In the Tx stack 410, the logic 400 may insert data at the MAC layer (412). The data may be encoded (414) in accord with a transport encapsulation protocol. The encoded data may be transcoded (415) by the logic 400 to alter the data rate of the system. The transcoding may facilitate compression of the data to make room for EC coding without necessarily altering lane speeds or baud rates. The data may then be scrambled (416) by the logic 400. The logic 400 may insert alignment markers (AM) (418) for the EC lanes and/or physical lanes. The logic 400 may encode (419) the data into EC lanes. In some cases, e.g., 200 Gb/s ports, 100 Gb/s ports, or other network interface port data rates, multiple independent EC encoders may be bit multiplexed to provide protection from burst errors, physical layer impairments, or other error sources. The logic 400 may distribute (420) the data among the physical lanes.

In the Rx stack 430, incoming data on the physical lanes may be demultiplexed (432) by the logic 400. The logic 400 may lock to the alignment markers (434) to deskew the logical lanes (436). The logic 400 may reorder the data (438). The logic 400 may perform EC decoding (439) to remove the EC lanes. The logic 400 may apply descrambling (440). The logic 400 may transcode (441) the data back to the original data rate. The logic 400 may decode (442) the data from the virtual lanes. The logic 400 may send the data may to the MAC layer (444).

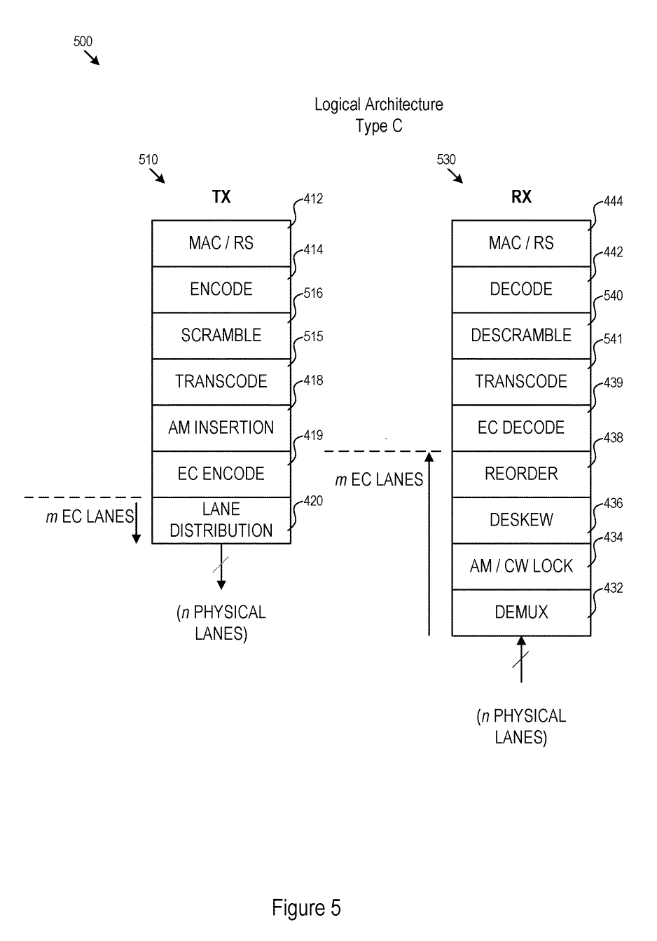

Moving to FIG. 5 another example error correcting coding logic 500 is shown. In the second example logic 500 the position of the transcoding (515) and scrambling (516) layers within the Tx stack 510 have been inverted with respect to logic 400 shown in FIG. 4. Similarly, descrambling (540) and return transcoding (541) have been inverted in the Rx stack 530. The inversion of these layers may facilitate compatibility with legacy standards. For example, some implementations the logic 500 may be paired with bit-mux gear boxes over network interface ports to provide backwards compatibility legacy multi-lane standards, e.g., IEEE 802.3 100 GbE. In an example scenario, a device using 50 Gb/s lanes may interoperate with an IEEE 802.3bj device, using an intermediate bit-mux gearbox on the physical lanes to combine 4×25 Gb/s into 2×50 Gb/s.

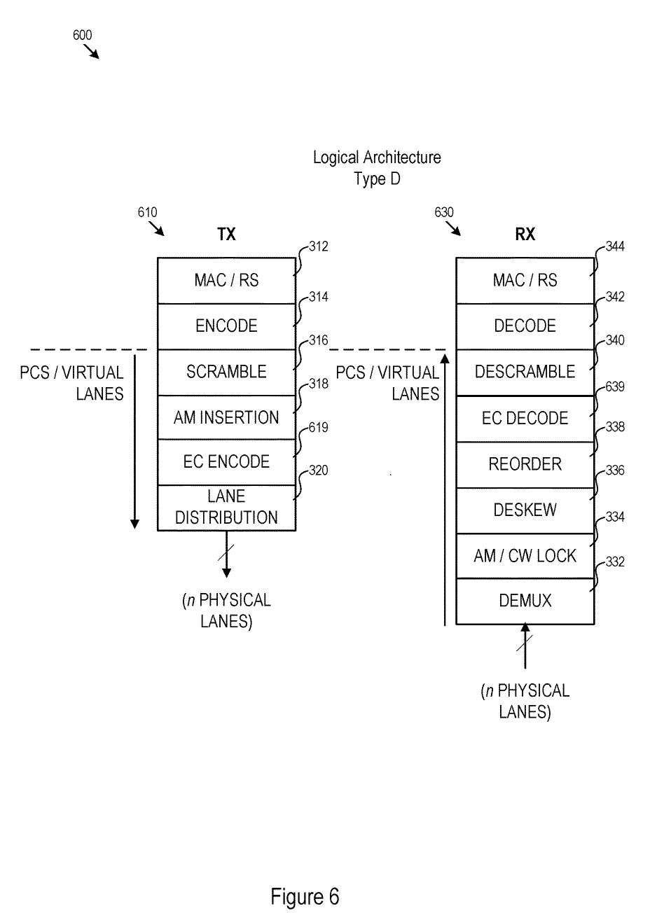

Moving on to FIG. 6, yet another example of error correcting coding logic 600 is shown. In the logic 600, FEC encoding, e.g., Base-R FEC encoding, is applied to data distributed in virtual lanes. Hence, the Tx stack 610 includes an additional FEC encoding layer (619) in relation to the Tx stack 310 of the logic 300, shown in FIG. 3. Further, the Rx stack 630 includes an additional EC decoding layer (639) in relation to the Rx stack 330 of the logic 300. The example the logic 600 may facilitate interoperability with systems using virtual lane encoding along with EC encoding on the virtual lanes, such as, 25/50G Consortium 50G PCS compliant systems.

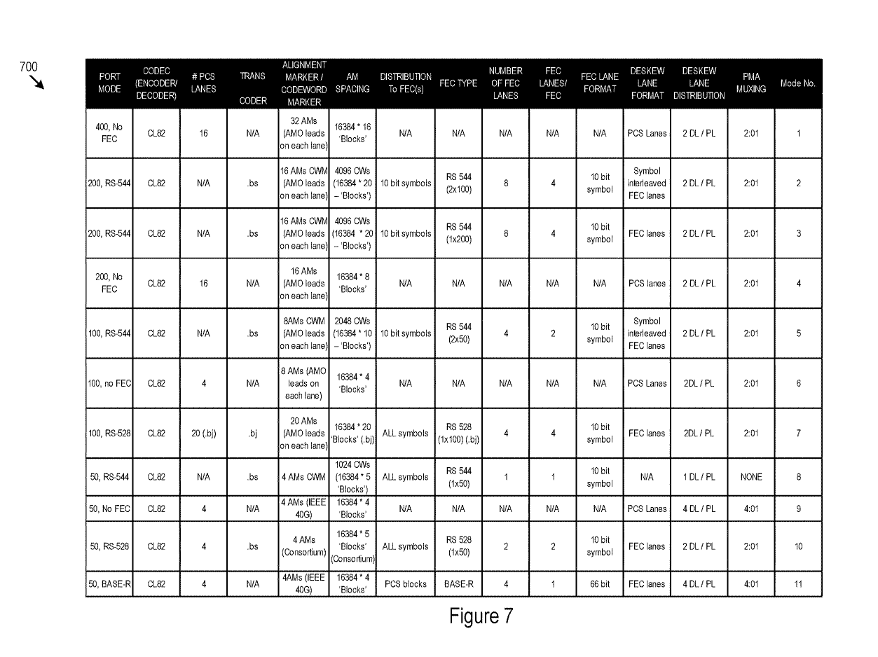

FIG. 7 show example network interface transmission port mode parameters 700. The example network interface transmission port mode parameters 700 may be used in various implementations of the example network interface port modes in Table 1 above. For the various implementations, the example network interface transmission port mode parameters 700 may specify a codec (e.g., CL82 codec); the number of PCS lanes; transcoder type (e.g., .bs, .bj); number of alignment markers/codeword (CW) markers per group, the number of blocks between alignment marker groups, the distribution mode to FEC units (e.g., FEC coding blocks); the FEC type; the number of FEC lanes; the numbers of FEC lanes per FEC unit; the FEC lane format (e.g., symbol type); the format for deskewing lanes; the deskew lane distribution; and physical medium attachment (PMA) muxing format. The example network interface transmission port mode parameters 700 are paired with example network interface port mode numbers from Table 1, above.

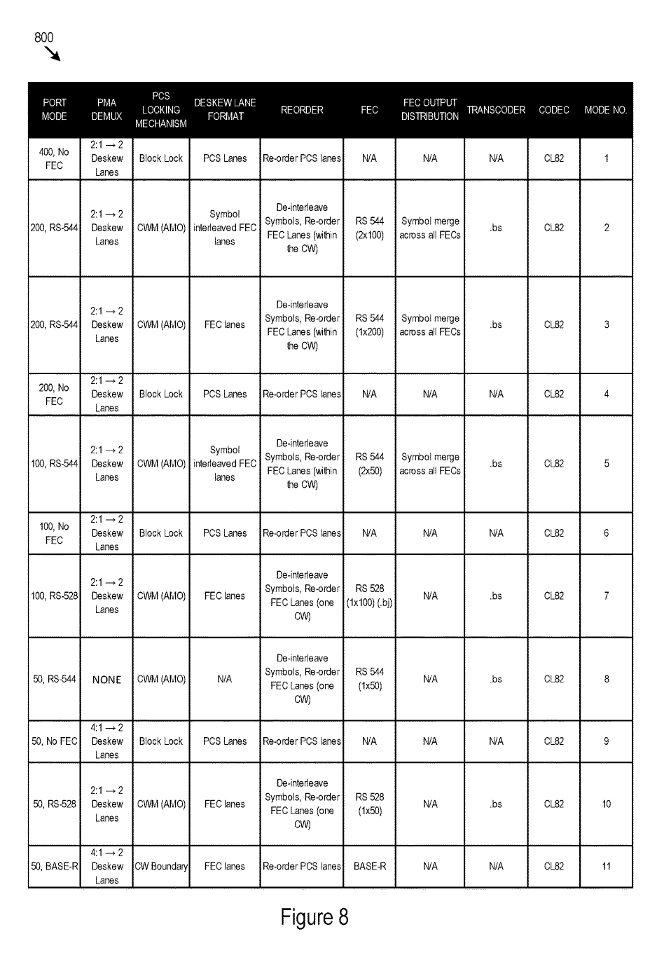

FIG. 8 show example network interface reception port mode parameters 800. The example network interface reception port mode parameters 800 may be used in various implementations of the example network interface port modes in Table 1 above. For the various implementations, the example network interface reception port mode parameters 800 may specify the PMA demuxing format; the locking mechanism for logical PCS lanes; the format for deskewing lanes; the process for reordering received data (e.g., by lane, codeword, or other reordering); the FEC type; the distribution mode of the FEC output; transcoder type (e.g., .bs, .bj); and a codec (e.g., CL82 codec). The example network interface reception port mode parameters 800 are paired with example network interface port mode numbers from Table 1, above.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

Various implementations have been specifically described. However, many other implementations are also possible.

What is claimed is:

1. A device comprising:
a network interface port configured to couple to a physical transmission medium adapted to support data transmission over a transmission lane set including at least one physical transmission lane; and
network coding circuitry coupled to network interface port, the network coding circuitry configured to:
receive transmission data at a media access control (MAC) layer of a network computing stack running on the network coding circuitry, the transmission data characterized by an order; and
encode the transmission data in accord with a with a transport protocol characterized by a first data rate to generate encapsulated data;
transcode the encapsulated data to shift the encapsulated data to a second data rate;
after encoding the transmission data but before transcoding the encapsulated data, scramble the order of the to reduce a likelihood of an occurrence of a challenging sequence within the encapsulated data after scrambling; and
distribute the encapsulated data to the transmission lane set.

2. The device of claim 1, where the network coding circuitry is configured to shift the encapsulated data to a second data rate by compressing the encapsulated data to provide bandwidth for error correction blocks within a physical transmission lane at the first data rate.

3. The device of claim 2, where the network coding circuitry is configured to distribute the encapsulated data over four forward error correction (FEC) logical lanes after compressing the encapsulated data.

4. The device of claim 3, where the network coding circuitry is configured to join the four logical FEC lanes into a FEC unit.

5. The device of claim 4, where the network coding circuitry is configured to insert error correction blocks into the encapsulated data after compressing the encapsulated data, the error correction blocks comprising Reed-Solomon FEC blocks using 528 symbols per unit.

6. The device of claim 1, where the network coding circuitry is configured to:
distribute the encapsulated data into one or more physical coding sublayer (PCS) logical lanes of the PCS sublayer of the network computing stack; and
inserting AM markers in groups with a periodic spacing between groups.

7. The device of claim 6, where the periodic spacing comprises 16384 blocks.

8. The device of claim 7, where the network coding circuitry is configured to distribute the encapsulated data into the one or more PCS logical lanes by distributing the encapsulated data into 20 pcs logical lanes.

9. The device of claim 1, where the network coding circuitry is configured to encode the transmission data by assigning the encapsulated data to one or more physical transmission lanes configured to carry the encapsulated data at the first data rate.

10. The device of claim 1, where the network coding circuitry is configured to shift the encapsulated data to a second data rate by accessing gearbox logic to change a number of physical transmission lanes in the transmission lane set over which the encapsulated data is distributed from a first number of physical transmission lanes at the first data rate to a second number of physical transmission lanes at the second data rate, the second number different from the first.

11. A method comprising:
receiving data for transmission data at a media access control (MAC) layer of a network computing stack, the transmission data characterized by an order; and
encoding the transmission data in accord with a with a transport protocol to generate encapsulated data;
after encoding the transmission data, scrambling the order of the to reduce a likelihood of an occurrence of a challenging sequence within the encapsulated data after scrambling;
inserting an alignment marker into the encapsulated data, the alignment marker comprising lane an indicator for membership among a transmission lane set including at least one physical lane;
distributing the encapsulated data into the transmission lane set; and
after inserting the alignment markers but before distributing the encapsulated data into the transmission lane set, applying error correction coding to the encapsulated data.

12. The method of claim 11, where encoding the transmission data in accord with a transport protocol comprises assigning the encapsulated data to four logical physical coding sublayer (PCS) logical lanes of the PCS sublayer of the network computing stack.

13. The method of claim 11, where inserting an alignment marker into the encapsulated data comprises inserting AM markers in groups with a periodic spacing between the groups.

14. The method of claim 13, where the periodic spacing comprises 16384 blocks.

15. The method of claim 14, where the block comprise blocks with a 66-bit payload.

16. The method of claim 11, where encoding the transmission data comprises assigning the encapsulated data to the one or more physical transmission lanes configured to carry the encapsulated data at the first data rate.

17. The method of claim 11, further comprising applying forward error correction (FEC) to the encapsulated data.

18. The method of claim 17, further comprising applying FEC to the encapsulated data comprises distribution of the encapsulated data over four FEC lanes.

19. The method of claim 18, where the FEC is characterized by Base-R type coding that uses a cyclic fire code.

20. A device comprising:
a network interface port configured to couple to a physical transmission medium adapted to support data transmission over a transmission lane set including at least one physical transmission lane;
network coding circuitry coupled to the network interface port, the network coding circuitry configured to:
receive transmission data at a media access control (MAC) layer of a network computing stack running on the network coding circuitry, the transmission data characterized by an order; and
determine, at a physical coding sublayer (PCS) of the network computing stack, logical PCS lane assignments to multiple logical PCS lanes for the transmission data;
encode the transmission data in accord with a with a transport protocol to generate encapsulated data, the transport protocol characterized by a data rate of 50 Gb/s for each physical transmission lane in the transmission lane set;
insert a first alignment marker into the encapsulated data, the alignment marker comprising lane an indicator for assignment an individual one of the multiple logical PCS lanes, the first alignment marker inserted at a spacing of 16384 blocks from a previous alignment marker sent on the individual one of the multiple logical PCS lanes;
after encoding the transmission data but before inserting the alignment marker, scramble the order of the encapsulated data to reduce a likelihood of an occurrence of a challenging sequence within the encapsulated data after scrambling;
distribute the encapsulated data over the transmission lane set; and
modulate the encapsulated data onto the transmission lane set in accord with a pulsed amplitude modulation (PAM) scheme comprising four PAM symbols and at a rate of 25.78125 GSymbol/s.
